(19) United States
(12) Patent Application Publication
(10) Pub. No.: US 2015/0200462 A1
(43) Pub. Date: Jul. 16, 2015

(54) REDUCED SURFACE AREA ANTENNA APPARATUS AND MOBILE COMMUNICATIONS DEVICES INCORPORATING THE SAME

(71) Applicant: Pulse Electronics, Inc., San Diego, CA (US)

(72) Inventor: Timo Leppaluoto, Suzhou (CN)

(21) Appl. No.: 14/558,562

(22) Filed: Dec. 2, 2014

Related U.S. Application Data
(60) Provisional application No. 61/911,418, filed on Dec. 3, 2013.

(51) Int. Cl. H01Q 9/04; H01Q 1/24

(52) U.S. Cl. CPC H01Q 9/0414; H01Q 1/243

(57) ABSTRACT

Space- and cost-efficient antenna apparatus and methods of making and using the same. Antenna may comprise one or more planar radiator elements fabricated from an electrically conductive material. Surface area of the antenna radiator metallized portion may be reduced by utilizing a crosshatch pattern. The pattern may comprise of one or more metal-free elements disposed within the outline of the radiator. The elements may be interconnected by conductive crosslinks. The antenna may be coupled to radio electronics at one or more connection points. At least one of a size and/or a placement of the crosslinks may be configured based on distance from the connecting points. Crosslink size and/or placement may be configured to provide a prescribed current flow within the antenna. Reducing surface area of the antenna radiator may reduce manufacturing time and/or cost compared with prior art antenna design approaches.

### PRIORITY

This application claims the benefit of priority to co-owned U.S. Provisional Patent Application Ser. No. 61/911,418 entitled “Reduced Surface Area Deposition Antenna Apparatus and Methods”, filed Dec. 3, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technology Field

The present disclosure relates generally to antenna apparatus for use in electronic devices such as wireless or portable radio devices, and more particularly in one exemplary aspect to antennas manufactured using the deposition of conductive materials, and methods of making and utilizing the same.

2. Description of Related Technology

Antennas are commonly found in most modem radio devices, such as desktop and mobile computers, mobile phones, tablet computers, smartphones, personal digital assistants (PDAs), or other personal communication devices (PCD). Typically, these antennas comprise a planar metal radiator. The structure is configured so that it functions as a resonator at the desired operating frequency or frequencies. Typically, these antennas are located internal to the device (such as within the outer plastic housing), whether free-standing, disposed on a printed circuit board (PCB) of the radio device, or on another device component, so as to permit propagation of radio frequency waves to and from the antenna(s).

Recent advances in antenna manufacturing processes have enabled the construction of antennas directly onto the surface of a specialized material (e.g., thermoplastic material that is doped with a metal additive). The doped metal additive is activated by means of a laser in a process known as laser direct structuring (LDS), direct metal deposition (DMD), laser metal deposition (LMD) which enables the construction of antennas onto more complex 3-dimensional geometries. In various typical smartphone and other applications, the underlying smartphone housing, and/or other components which the antenna may be disposed on inside the device, may be manufactured using this specialized material, such as for example using standard injection molding processes. A laser is then used to activate areas of the (thermoplastic) material that are to be subsequently plated. Typically, an electrolytic copper bath followed by successive additive layers such as nickel or gold are then added to complete the construction of the antenna.

However, the foregoing manufacturing processes are comparatively costly, especially when considered on a per-area basis. Stated differently, reduction of the area of the (plated) antenna can significantly reduce the cost of manufacturing thereof, as well as requiring the use of less energy, process chemicals, etc. It can also afford a greater degree of design flexibility, in that various portions of the radiator element(s), feeds, etc. can be placed at different locations.

Accordingly, there is a salient need for a wireless antenna solution for e.g., a portable radio device that offers comparable electrical performance to prior art approaches while being manufactured at lower cost and using more flexible, manufacturing processes.

### SUMMARY

The present disclosure satisfies the foregoing needs by providing, inter alia, an improved antenna and flexible, low-cost methods of making and using the same.

In a first aspect of the disclosure, an antenna apparatus is disclosed. In one embodiment, the apparatus is for use in a portable communications device, and includes a conductor deposited on a component of the portable device (e.g., interior housing surface).

In another embodiment, the antenna includes a first radiating element having a first and a second branches thereof, and a connecting point; and a plurality of connecting elements disposed substantially between the first and the second branches.

In one variant, at least one of a size and/or a placement of the first and the second branches is configured based on a distance from the connecting point.

In another variant, at least one of a size and/or a placement of at least one of the connecting elements is configured based on a distance from the connecting point.

In a second aspect of the disclosure, a method of manufacturing a “cross-hatch” antenna apparatus is disclosed. In one embodiment, the method comprises depositing (whether by “ink jetting” or spraying or other means of deposition) a conductive fluid in a desired form, and then curing the deposited fluid using e.g., electromagnetic thermal energy flash, application of heat using other means, or other approach.

In another embodiment, the antenna is formed using a laser direct structuring (LDS) process. The antenna radiator may comprise metal-free areas configured to reduce, inter alia, antenna fabrication time.

In a third aspect of the disclosure, a portable radio device is disclosed. In one embodiment, the radio device is a cellular-enabled smartphone with a cross-hatch cellular band antenna. In another embodiment, the smartphone includes a Wi-Fi interface with a cross-hatch antenna. In yet another embodiment, the smartphone includes a GPS receiver with cross-hatch antenna.

In a fourth aspect of the disclosure, a method of manufacturing a portable radio device is disclosed. In one embodiment, the method includes depositing one or more antennas on a component (e.g., housing) of the device in a substantially three-dimensional configuration, the configuration being particularly adapted to the specific geometry and space requirements of that device.

In a fifth aspect of the disclosure, a method of operating an antenna apparatus is disclosed. In one embodiment, the method comprises coupling the antenna apparatus to a radio frequency transceiver, and exciting the apparatus using the transceiver

In a sixth aspect of the disclosure, a method of developing an antenna apparatus is disclosed. In one embodiment, the method comprises depositing a cross-hatch antenna (e.g., a wire-like loop) of a first configuration on a substrate; and subsequently depositing modified configurations of the wire loop antenna on other substrates, and testing the first (e.g., wire loop) antenna and the other configurations to identify more desirable operational features relating to the various configurations.

In a seventh aspect of the disclosure, a method of tuning an antenna apparatus is disclosed.

In an eighth aspect of the disclosure, a method of operating a mobile device is disclosed.

In a ninth aspect of the disclosure, a method of optimizing the performance of a cross-hatch type antenna element is disclosed. In one embodiment, the method includes selectively positioning one or more crossbar elements within the antenna element such as to optimize one or more performance attributes of the antenna, while also minimizing the amount of surface area covered by the radiating portion of the element.

Further features of the present disclosure, its nature and various advantages will be more apparent from the accompanying drawings and the following detailed description.

### BRIEF DESCRIPTION OF THE DRAWINGS

FIG. 1A is a top plan view of a planar antenna element of the prior art illustrating a raster pattern for use with direct metal deposition manufacturing methodology.

FIG. 1B is a top plan view of a reduced metal surface area planar antenna element in accordance with one implementation of the present disclosure.

FIG. 2 is a perspective view of a reduced-area antenna structure disposed on a three-dimensional substrate, in accordance with one implementation.

FIG. 3 is graphical illustration depicting a mobile communications device comprising the reduced-area antenna structure configured in accordance with the implementation shown in FIG. 2.

FIG. 4 is a perspective exterior view of one embodiment of a portable radio device illustrating placement of an exemplary reduced area antenna therein.

FIG. 5 is a logical flow diagram illustrating one embodiment of a generalized method of development testing of the reduced area antenna of the disclosure.

FIGS. 6A-7 illustrates exemplary performance data obtained by the Assignee hereof in prototype testing of various aspects of the disclosure.

All of the above listed Figures are ©Copyright 2013 Pulse Finland Oy. All rights reserved.

### DETAILED DESCRIPTION

Reference is now made to the drawings wherein like numerals refer to like parts throughout.

As used herein, the terms “antenna,” “antenna system,” “antenna assembly”, and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

As used herein, the terms “cure” and “curing” refer without limitation to a process whereby a flowable material is exposed to an agent (whether electromagnetic energy such as infrared, laser, or microwave), heat, or a chemical substance which causes a desirable mechanical or other property to occur within the flowable material. Typically, curing improves or imparts one or more desired properties, such as e.g., the electrical conductivity of the material and adhesion to the substrate.

As used herein, the term “deposition” refers without limitation to any type of process which deposits one material on another, including for example printing (e.g., of a flowable material, defined infra), jetting, plating, and vapor deposition.

As used herein, the term “flowable” refers without limitation to liquids, gels, pastes, ink formulations, solutions, colloidal suspensions, or other physical forms of substances which have the ability to flow in some manner, whether under force of gravity or other applied force.

The terms “frequency range”, “frequency band”, and “frequency domain” refer without limitation to any frequency range for communicating signals. Such signals may be communicated pursuant to one or more standards or wireless air interfaces.

As used herein, the terms “mobile device”, “portable device”, “consumer device” or “radio device” may include, but are not limited to, cellular telephones, smartphones, personal computers (PCs) and minicomputers, whether desktop, laptop, or otherwise, as well as mobile devices such as handheld computers, PDAs, personal media devices (PMDs), personal communication devices (PCDs) and/or any combinations of the foregoing, which utilize one or more antennas for emitting or receiving electromagnetic energy such as radio frequency energy.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”. “side”. “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

### Overview

The present disclosure provides, inter alia, improved time- and cost-efficient antenna apparatus and methods for making the same. An internal antenna component may be embodied for example in a mobile wireless device. The antenna in one embodiment includes one or more planar radiator elements fabricated from an electrically conductive material disposed on an internal component (e.g., chassis and/or housing) of the wireless device. The surface area of the antenna radiator metallized portion may be reduced by utilizing a pattern, such as e.g., a crosshatch pattern. The pattern includes one or more metal-free portions disposed within the outline of the radiator. The metal portion of the antenna radiator may be interconnected by conductive crosslinks or members. The antenna is coupled to radio electronics at one or more connection points.

In one variant, at least one of the size and/or a placement of the crosslinks is selectively chosen to obtain the desired performance, such as where the crosslinks are configured based on distance from the connecting points. Crosslink size and/or placement is configured to provide a prescribed current flow (and hence performance) within the antenna.

The internal antenna may be manufactured using a variety of metal deposition technologies, including but not limited to, for example, laser direct structuring (LDS), direct metal deposition (DMD), laser metal deposition (LMD), Direct metal laser sintering (DMLS), printing deposition (e.g., as described in U.S. patent application Ser. No. 13/782,993 entitled “DEPOSITION ANTENNA APPARATUS AND METHODS” filed Mar. 1, 2013, the contents of which are incorporated herein by reference in its entirety), vapor deposition (e.g., CVD), and/or other manufacturing technologies.

The exemplary embodiments of the antenna structure described herein advantageously enable a reduction of antenna manufacturing time and/or cost compared with prior art antenna design approaches. One or more additive manufacturing technologies may utilize a laser in order to convert metal-containing material (e.g., copper-containing powder). In accordance with the principles of the present disclosure, eliminating portions of the antenna metal surface can appreciably reduce time and materials required to build the antenna, in some implementations by reducing plating costs by up to 30% and lasering costs by up to 20%.

The foregoing antenna design methodology may be utilized with a variety of antenna types including for example, inverted F antenna, inverted L, and practically any planar or partly planar antenna structure that may be fabricated using an additive manufacturing technology.

### Detailed Description of Exemplary Embodiments

Detailed descriptions of the various embodiments and variants of the apparatus and methods of the disclosure are now provided. While primarily discussed in the context of wireless mobile devices, the various apparatus and methodologies discussed herein are not so limited. In fact, many of the apparatus and methodologies described herein are useful in any number of complex antennas, whether associated with mobile or fixed devices, that can benefit from the antenna methodologies and apparatus described herein.

### Exemplary Antenna Apparatus

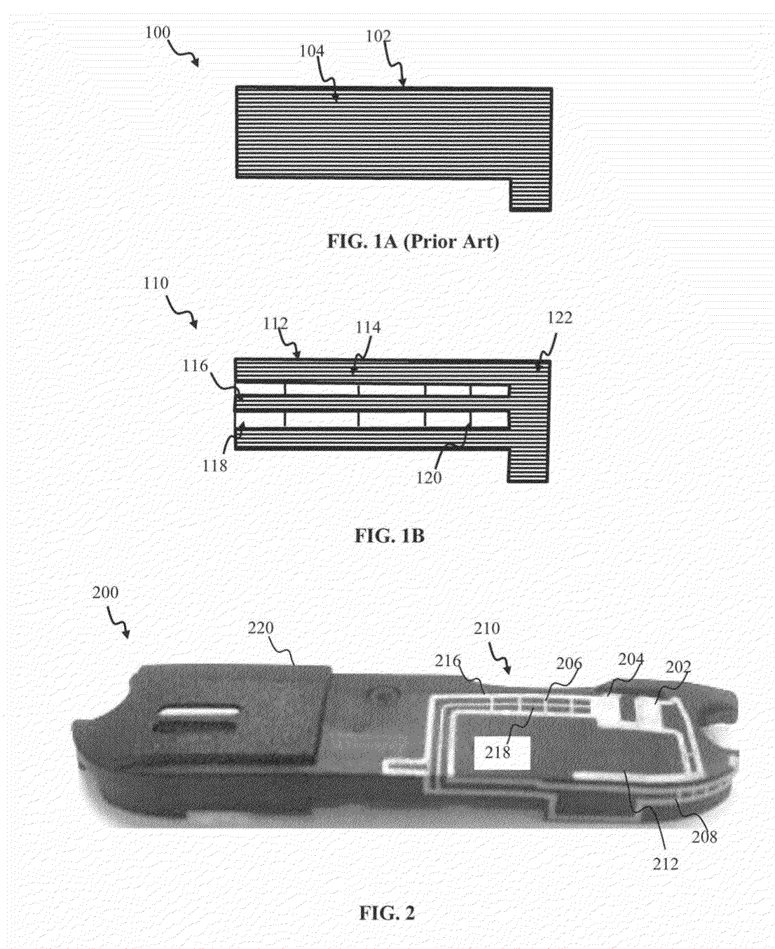

Referring now to FIGS. 1A-2, exemplary embodiments of the antenna apparatus of the disclosure are described in detail.

FIG. 1A illustrates a raster pattern for use with direct metal deposition manufacturing of a planar antenna element of the prior art. The illustrated antenna element 100 is characterized by an outline 102 (shown by a bold line in FIG. 1A). The element 100 may be fabricated using a variety of metal deposition technologies, including but not limited to, for example, laser direct structuring (LDS), direct metal deposition (DMD), laser metal deposition (LMD), direct metal laser sintering (DMLS), flowable conductive deposition, vapor deposition, and/or other manufacturing technologies. During fabrication using, e.g., LDS or DLMS, a laser beam may be moved in a raster pattern within the antenna outline 102. The pattern (shown by lines 104 in FIG. 1A) may comprise any number of individual passes (e.g., 10 to 100 passes). Laser beam footprint width may be selected as desired, such as e.g., between 0.1 mm and 2 mm. In one implementation shown and described with respect to FIG. 2, the LDS laser beam dot size is 80 μm and is typically used with an overlap of 50% to ensure good lasering of the surface so that the pitch is 40 μm (i.e. half the laser beam dot size. Accordingly, a 0.5 mm track width would require approximately eight to nine (8-9) passes of the laser. The raster pattern may further include several vertically arranged passes (not shown) of the laser beam that may be utilized in order to, inter alia, build up the element 100 to target thickness (e.g., 0.5 mm to 1.5 mm in some implementations). Traversal of the individual raster pattern segments may take between e.g., 1 second to do from between thirty (30) square mm and sixty (60) square mm with a typical laser beam move speed of between 2600 mm/s to 3000 mm/s. It may therefore be advantageous to reduce antenna deposition time so as to reduce antenna cost and/or increase manufacturing throughput. In one variant of the present disclosure, this deposition time is reduced by obviating portions of the deposited antenna's surface area which are electrically “unnecessary”. Moreover, cost reduction during the actual plating process by using the lasering processes discussed herein have negligible cost reductions for typical Cu/Ni plating as more chemicals are wasted in the plating process than are actually used to plate. Meaningful reduction is achieved from products that require Au plating.

FIG. 1B illustrates a reduced metal surface area planar antenna element in accordance with one implementation of the present disclosure. The antenna element 110 is characterized by an outline 112 (shown by a bold line in FIG. 1B) purely for purposes of illustration. Portions of the antenna 110 metal surface within the outline 112 may be removed (e.g., the portion 118). The antenna 110 may comprise one or more conductive portions (e.g., 116) separated by the metal-free non-conductive (e.g., “blank”) portions 118. The metal portions (e.g., 116) of the antenna radiator 110 may be interconnected by conductive crosslinks 120. The antenna may be coupled to radio electronics at one or more connection points, e.g., 122 in FIG. 1B. At least one of a size and/or a placement of the crosslinks 122 may be configured based on distance from the connecting point 122. The antenna structure 110 may be referred to as the crosshatch and/or X-hatch structure.

It will be appreciated that in certain embodiments, the underlying preparation for metallization is applied to the entire surface area subsumed by the antenna radiator (and other components, such as feeds, etc.), yet the metallization of that area is only applied selectively to a smaller portion thereof. For example, in one LDS-based variant, the entire surface area circumscribed by the border of an antenna radiator is made capable of being laser activated, yet the laser activation is actually only applied to a portion of that area (e.g., corresponding to the exemplary cross-hatch pattern described elsewhere herein). This approach may be useful where, e.g., it is more costly to accurately define the shape of the ultimate antenna radiator that will be metalized in the substrate, and hence easier and less costly to merely prepare the whole area for possible activation/metallization, and then selectively activate and/or metalize to form the desired final radiator pattern. This logic can be applied to literally any step of the formation process as desired; i.e., where cost and/or material efficiencies are best served by only accurately defining the final radiator pattern where absolutely necessary. For instance, a final or top coating over the top of the radiator may be applied over the entire area (as opposed to having to mask or otherwise specifically delineate the radiator pattern) without affecting the electrical performance of the radiator.

During fabrication of the antenna 110 using, e.g., DLMS, a laser beam may be moved in a raster pattern within the antenna outline 112. The exemplary pattern is shown by the lines 114 in FIG. 1B. Comparing the reduced metal surface area antenna structure 110 the antenna structure of the prior art (e.g., the structure 100 of FIG. 1A), it may be seen that the pattern 114 of the antenna 110 may be manufactured using, e.g., fewer passes of a laser beam, thereby reducing antenna fabrication time using metal deposition processes.

In one exemplary embodiment, the antenna structure 110 may be formed onto a substrate via a deposition process that uses a Plowable conductive liquid, e.g., as described in U.S. patent application Ser. No. 13/782,993 entitled “DEPOSITION ANTENNA APPARATUS AND METHODS” filed Mar. 1, 2013), incorporated supra. A described in the above-referenced application, a conductive liquid may deposited onto a substrate in a desired thickness and according to a target pattern (e.g., the pattern of the structure 110), so as to form a radiating/receiving antenna structure directly on the substrate. Reducing the surface area that is to be covered by the conductive material (e.g., by removing portions 118), antenna manufacturing time and material needed may be reduced, compared to the antenna design of FIG. 1A The deposited conductive material is then cured (using e.g., electromagnetic radiation, heat, and/or chemical process) so as to render the conductive fluid mechanically stable, notably without any subsequent process steps such as plating.

FIG. 2 illustrates an antenna apparatus with reduced metal surface area in accordance with one implementation. The antenna apparatus 200 includes in one embodiment an antenna structure 210 disposed on a three-dimensional substrate 220. The structure 210 may include one or more connection structures, e.g., the feed structure 202 and a ground structure 204 as shown in FIG. 2. The antenna 210 may be configured to operate in one or more frequency bands. In some implementations, antenna operational bands may comprise a lower frequency band and an upper frequency band, such as e.g., those useful within one or more cellular or other wireless standards as described elsewhere herein. For example, the first antenna radiator portion 212 may be configured to support antenna operation in an upper frequency band, while the second antenna radiator portion 208 may be configured to support antenna operation in a lower frequency band.

As shown in FIG. 2, individual antenna portions may be disposed one or more surfaces, e.g., the portions 216, 202, 206, 212 disposed on the upper surface, while the radiator portion 208 is disposed on a (bottom) surface of the substrate 220. The lower and/or the upper frequency bands may comprise one or more individual bands configured to support one or more communications standards (e.g., Global System for Mobile Communications (GSM), Long Term Evolution (LTE), Wideband Code Division Multiple Access (W-CDMA), Code Division Multiple Access (CDMA), and/or other standards. For example, in one or more implementations, the lower frequency band may comprise one or more of the following: LTE 12 (698-746 MHz), LTE 17 (704 MHz to 746 MHz), LTE 13 (746 MHz to 787 MHz), LTE 14 (758 MHz to 798 MHz), LTE 20 (791 to 862 MHz), GSM850 (824 MHz to 894 MHz), E-GSM-900 (880 MHz to 960), and/or other bands. The upper frequency band may comprise e.g., one or more of the following: DCS 1800 (1710 MHz to 1880 MHz), PCS1900 (1850 MHz to 1990 MHz), WCDMAI (1920 MHz to 2170 MHz), LTE 7 (2500 MHz to 2690 MHz) and/or other bands. Mixtures of different cellular standards (e.g., a lower band associated with one standard, and a comparatively higher frequency band for another standard), as well as cellular and non-cellular standards (or two non-cellular standards, such as Bluetooth and Wi-Fi, or Wi-Fi and GPS), are also contemplated.

The antenna structure 210 may be implemented using the exemplary reduced surface metal area methodology, e.g. such as described above with respect to FIG. 1B. The radiator portion of the antenna structure 210 may comprise one or more cross-hatch structures, wherein the conductive portions (e.g., 216) are separated by metal-free portions (e.g., 218). As used herein, the term “cross-hatch” refers without limitation to any configuration of two or more conductive traces or paths with at least a portion of the area in-between removed or not metalized. For example, the term may be applied to a lattice, repeating or non-repeating removal or non-metallization pattern (e.g., circular, polygonal, elliptical, etc.), or yet other variants.

In the exemplary embodiment, a plurality of crosslink elements (e.g., 206) are disposed to connect the one or more conductive portions. In some implementations, crosslink size, shape, and/or placement may be configured based on one or more factors, such as e.g., distance from the connecting point (e.g., 204). Particularly, it has been recognized by the inventors of the present disclosure that the placement of the crosslink element(s) relative to the connecting point can affect antenna performance. For example, the crosslink elements can typically start a minimum distance of 8 mm from the antenna/feed/ground point(s). In one or more implementations, crosslink 206 size and/or placement is configured to provide a prescribed current flow within the antenna 200. It has been found by the Assignee hereof that the distance of the crosslinks must be smaller than lambda/4 at the highest operating frequency of the antenna in order to avoid any unwanted slot resonances.

By employing the aforementioned exemplary “cross-hatch” design, total metal surface area of the antenna structure 210 may be significantly reduced; e.g., from 189.4 mm² (for a solid metal surface antenna design absent metal free portions 218 in FIG. 2) to 118.8 mm². This represents a 60% reduction in the metal surface area of the exemplary antenna. Fabrication time of the antenna structure 210 may be reduced accordingly when using LDS manufacturing methodology characterized, e.g., by the laser beam footprint width of 0.5 mm. For example, a laser beam may be moved in a raster pattern within the outline of the antenna structure 210. Reduction of the metal surface area of the antenna structure 210 (compared to the solid antenna design structure of the prior art) may reduce time and/or cost of the antenna 200 and/or increase manufacturing throughput.

### Exemplary Mobile Device Configuration

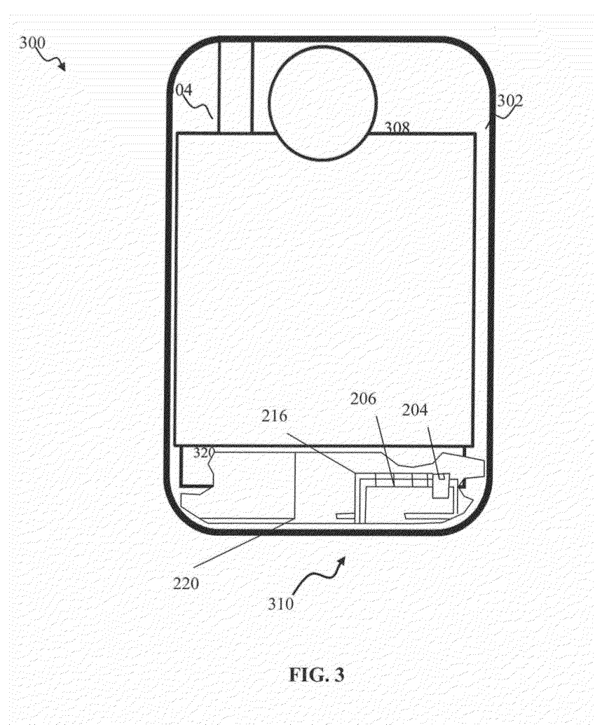

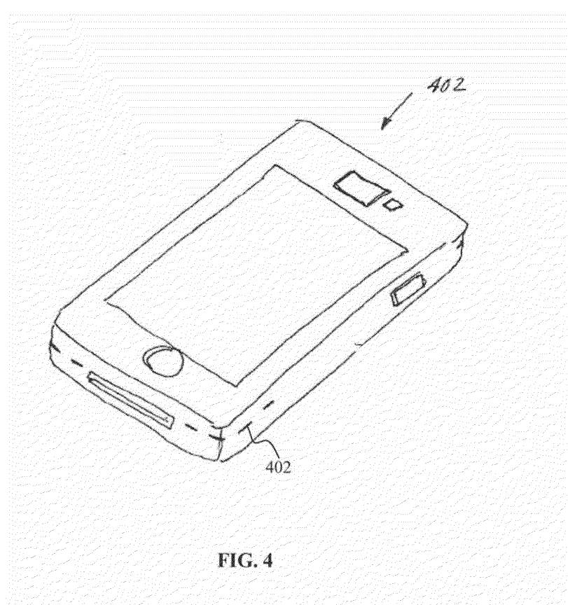

FIG. 3 illustrates one embodiment of a mobile communications device comprising the reduced-area antenna structure configured in accordance with the implementation shown in FIG. 2. The mobile apparatus 300 includes the reduced metal area antenna 310 disposed on the substrate 220, within the device enclosure 302 (here, at the bottom of the device, although any number of locations and orientations are possible. The antenna 310 may be coupled to a radio frequency driver or transceiver 320. The device may furtherer include other components such as e.g., a camera 308, a battery 306, an audio connector 304, and/or other components (e.g., processing electronics, user interface device).

One or more antenna 310 portions disposed within each of a number of different planes of the substrate 220; e.g., a plane parallel to the device main plane (e.g., the battery 306 plane), and a plane arranged perpendicular to the device main plane.

FIG. 4 is a perspective view of one embodiment of a portable radio device (e.g., smartphone) 402, illustrating the placement of an exemplary reduced area antenna 400 therein (shown as a dotted line so as to reflect the fact that the antenna may be disposed at least partly underneath or within the outer edge surfaces of the device.

Moreover, while exemplary embodiments herein are described primarily in terms of mobile devices, the apparatus and methods of the disclosure are in no way so limited, and may in fact be applied to any radio device which uses an antenna, whether fixed, mobile, semi-mobile, or otherwise.

As is well known, high-volume consumer devices such as smartphones may comprise any number of different form factors, including for example: (i) a substantially planar device with touch-screen display (FIG. 4); (ii) a “candy bar” type; (iii) a slide-out or fold-out keyboard device (not shown), and/or other configurations. The antenna apparatus and methods of the present disclosure are particularly well suited to such high-volume consumer devices, since they afford an appreciable manufacturing cost savings (thereby making for reduced device prices). Likewise, the antennas disclosed herein may be readily applied to tablets, handheld computers, gaming devices, “smart” TVs/remotes, smart watches, or any number of other electronic devices.

### Development

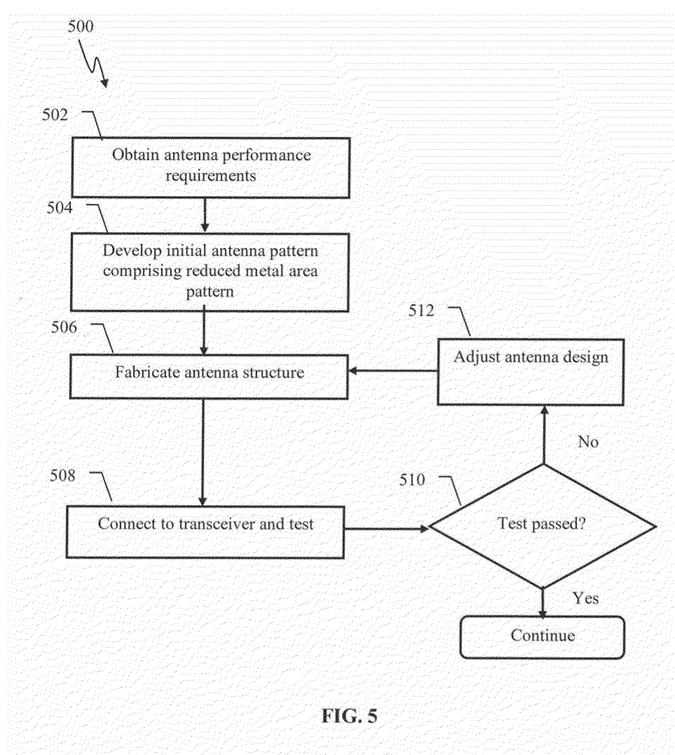

FIG. 5 is a logical flow diagram illustrating one embodiment of a generalized method of development testing of the reduced metal area antenna of the disclosure.

As will be appreciated by those of ordinary skill in the antenna arts, significant trial-and-error in terms of physical implementations of an antenna may be often required, due in part to factors such as imperfections in materials, imperfections in computerized antenna modeling software, and unknown or unanticipated effects from components present in the production device (e.g., metallic components such as frames, buttons, wires, etc.). Stated simply, the assembled device may not operate exactly as anticipated by modeling, or even as expected based on earlier tests performed when the device was not assembled.

Moreover, even after the device has been assembled, effects of other factors such as the placement of the user's hand, proximity to the user's head, etc. may impact the efficacy or operation of the antenna.

Hence, in another aspect, the present disclosure may advantageously reduce manufacturing time, thereby facilitating faster prototyping, tuning and testing of various antenna configurations to a level which may not be readily achievable with prior art technologies. Specifically, the present disclosure allows, in one exemplary approach, the ability to readily manufacture multiple antenna patterns, shapes, widths, thicknesses, cross-hatch patterns, so as to e.g., evaluate the effects thereof on antenna performance, and/or perform sensitivity analysis for the various parameters.

At step 502 of method 500, one or more antenna performance requirements may be obtained. In some implementations, the requirements may include antenna total efficiency, operating bands, size, return loss in one or more bands, manufacturing time, band isolation, and/or other antenna characteristics.

At step 504 of method 500, an initial antenna configuration may be developed. In some implementations, the initial configuration may comprise e.g., a portion of the antenna outline 122, size and/or placement of crosslinks 120 in FIG. 1B. The configuration or portions thereof may be obtained through e.g., “intelligent guessing” and/or prior knowledge of behavior based on, inter alia, the requirement(s) identified in step 502, computer model in or simulation, and/or other approaches.

At step 506 antenna structure is fabricated. The fabrication may be effectuated using, e.g., an additive manufacturing technology (e.g., LDS, or Plowable conductive deposition, vapor deposition, etc.). Moreover, it will be recognized that the structure need not necessarily be finally manufactured, but rather need only replicate a production device in critical attributes that may affect performance. For instance, one or more processing steps (such as curing, protective coatings, etc.) used in manufacturing the production antenna structure may be obviated to save prototyping time/cost if they do not have any bearing on electrical performance.

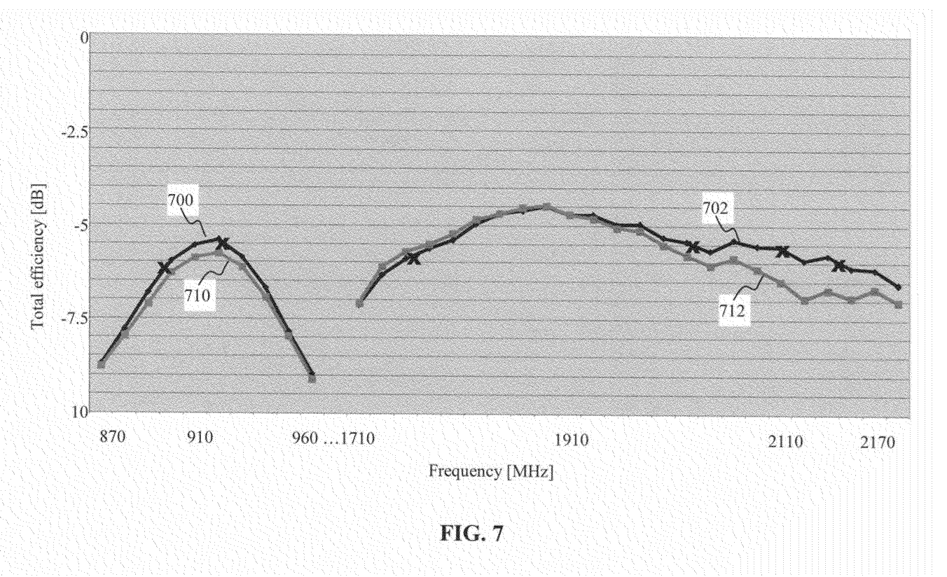

At step 508 of method 500, the fabricated antenna may be connected to a transceiver or other operational element, and tested. In one or more implementations, the antenna tests may include determination of antenna efficiency, response, directionality, etc., such as described below with respect to FIGS. 7A-7B.

At step 510 of method 500, a determination may be made as to whether the test results match, or are otherwise sufficient for, the target requirement(s) established e.g., at step 502.

Responsive to a determination that the test results do not match or are otherwise insufficient for the target requirement(s), the method 500 proceeds to operation 512, wherein antenna design is adjusted. In one or more implementations, the design adjustment may comprise modifying size, shape, and/or position of antenna metal portions (e.g., 116) and/or metal-free portions (e.g., 118 in FIG. 1B), and/or the crosslinks (e.g., 120). For example, the placement and/or number of cross-links may be changed. Additionally (or alternatively), the size and/or shape of the metal-free portions can be altered. Subsequent to these antenna design modifications being identified, the method 500 may proceed to step 506, wherein a revised antenna component is fabricated and tested, and the process 500 iterates as necessary until the desired test/target criteria are satisfactorily met.

### Performance

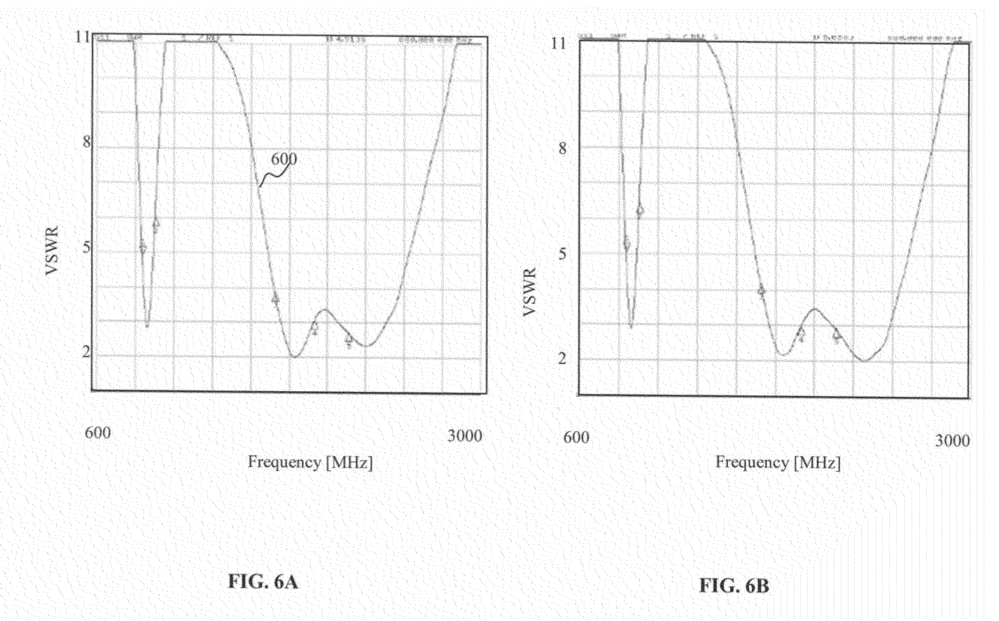

Referring now to FIGS. 6A-7, performance results obtained during testing by the Assignee hereof of exemplary antenna apparatus constructed according to the disclosure are presented.

Data presented in FIG. 6A depict free-space voltage standing wave ratio (VSWR) (in dB) as a function of frequency for the exemplary cross-hatch antenna design shown in FIG. 2. Data presented in FIG. 6B depict free-space VSWR as a function of frequency for a solid metal antenna (i.e., non cross-hatch) design corresponding to the cross-hatch antenna of FIG. 2. Comparison of curves 600 and 602 in FIGS. 6A-6B confirms that the exemplary embodiment of the cross-hatch antenna structure of the present disclosure is capable of matching the electrical performance of a solid metal surface antenna design, while providing the appreciable manufacturing, cost, and other benefits discussed previously herein.

FIG. 7 presents data regarding free-space efficiency obtained for the antenna configurations described above with respect to FIGS. 6A-6B. Efficiency of an antenna (in dB) is may be defined decimal logarithm of a ratio of radiated to input power:

$$AntennaEfficiency = 10 {log}_{10} ( \frac{Radiated Power}{Input Power} ) \qquad ( Eqn . 1 )$$

An efficiency of zero (0) dB corresponds to an ideal theoretical radiator, wherein all of the input power is radiated in the form of electromagnetic energy.

Curves marked with designators 710, 712 denote data obtained with the exemplary cross-hatch antenna design shown in FIG. 2 in a lower frequency band and upper frequency band, respectively. Curves marked with designators 700, 702 and the marker ‘x’ denote data obtained with the solid metal antenna design corresponding to the crosshatch antenna of FIG. 2 in the lower and the upper frequency bands, respectively. Comparing antenna efficiency data shown by the curve 700 and the curve 710, it may be seen that the exemplary cross-hatch antenna structure of the present disclosure is capable of matching the traditional full metal surface antenna efficiency to within 0.5 dB over frequency range between 870 MHz and 960 MHz. Similarly, comparing data shown by the curve 702 and the curve 712, it may be seen that the exemplary cross-hatch antenna structure of the present disclosure is further capable of matching the traditional full metal surface antenna efficiency to within 0.25 dB over frequency range between 1710 MHz and 1920 MHz, and to within 1 dB over frequency range between 1920 MHz and 2170 MHz.

The present disclosure provides, inter alia, an antenna structure configured with a cross-hatch pattern, wherein a portion of the antenna surface metal may be eliminated. As discussed above, strategically placed crosslinks or other similar elements may be utilized in order to provide for a prescribed current flow within the antenna. Reducing antenna solid metal surface area (e.g., by 60% in some implementations) advantageously enables substantial reduction of the antenna fabrication time using additive manufacturing processes (e.g., LDS or deposition) as compared to the “full metal” antenna design of the prior art.

The antenna design methodology described herein reduces antenna manufacturing cost without sacrificing antenna performance. Test results confirm that removal/elimination of solid metal portions from the antenna surface, when accompanied by appropriately sized and placed crosslinks or comparable elements, does not materially degrade antenna performance and moreover, the design/prototyping process may be significantly facilitated as well.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims herein.

While the above detailed description has shown, described, and pointed out novel features of the disclosure as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles of the disclosure.

What is claimed is:

1. An antenna apparatus with a reduced metal surface area, comprising:
an antenna structure disposed on a three-dimensional substrate, the antenna structure, comprising:
one or more connection structures; and
a radiator portion comprising one or more cross-hatch structures.

2. The antenna apparatus of claim 1, wherein the one or more connection structures comprises a feed structure and a ground structure.

3. The antenna apparatus of claim 2, wherein the antenna structure is configured for operation in a plurality of frequency bands, the plurality of frequency bands comprising an upper frequency band and a lower frequency band.

4. The antenna apparatus of claim 1, wherein the one or more cross-hatch structures, comprises:
a first branch and a second branch; and
a plurality of connecting elements disposed substantially between the first and the second branches.

5. The antenna apparatus of claim 4, wherein at least one of a size and/or a placement of the first and the second branches is configured based on a distance from the one or more connection structures.

6. The antenna apparatus of claim 5, wherein the one or more connection structures comprises at least one of a feed structure and a ground structure.

7. The antenna apparatus of claim 6, wherein at least one of a size and/or a placement of at least one of the plurality of connecting elements is configured based on a distance from at least one of the feed structure and the ground structure.

8. The antenna apparatus of claim 4, wherein a configuration of at least one of the plurality of connecting elements is based at least in part on achieving a desired current flow.

9. The antenna apparatus of claim 1, wherein the radiator portion comprising the one or more cross-hatch structures, comprises:
a first radiator structure disposed on a first surface of the three-dimensional substrate; and
a second radiator structure disposed on a second surface of the three-dimensional substrate, the first and second surfaces being different surfaces.

10. The antenna apparatus of claim 1, wherein the radiator portion comprising the one or more cross-hatch structures is configured to reduce a conductive surface area of the antenna structure as compared with an antenna structure with no cross-hatch structures.

11. A reduced-area antenna element, comprising:
a first radiating element having a first and a second branches thereof, and a connecting point; and
a plurality of connecting elements disposed substantially between the first and the second branches.

12. The antenna element of claim 11, wherein at least one of a size and/or a placement of the first and the second branches is configured based on a distance from the connecting point.

13. The antenna element of claim 11, wherein at least one of a size and/or a placement of at least one of the plurality of connecting elements is configured based on a distance from the connecting point.

14. The antenna element of claim 11, wherein a configuration of at least one of the plurality of connecting elements is based at least in part on achieving a desired current flow.

15. A mobile communications device, comprising:
a device enclosure and a substrate disposed within the device enclosure;
a radio transceiver; and
a reduced-area antenna element disposed on the substrate, the reduced-area antenna element, comprising:
a first radiating element having a first and a second branches thereof, and a connecting point; and
a plurality of connecting elements disposed substantially between the first and the second branches.

16. The mobile communications device of claim 15, wherein the reduced-area antenna element is constructed from a laser direct structuring (LDS) process.

17. The mobile communications device of claim 16, wherein at least one of a size and/or a placement of the first and the second branches is configured based on a distance from the connecting point.

18. The mobile communications device of claim 16, wherein at least one of a size and/or a placement of at least one of the plurality of connecting elements is configured based on a distance from the connecting point.

19. The mobile communications device of claim 16, wherein a configuration of at least one of the plurality of connecting elements is based at least in part on achieving a desired current flow.

20. The mobile communications device of claim 16, wherein the reduced-area antenna element is configured to operate in a plurality of frequency bands, the plurality of frequency bands comprising at least an upper operating frequency band and a lower operating frequency band.
